(19) United States
(12) Patent Application Publication
(10) Pub. No.: US 2011/0305040 A1
(43) Pub. Date: Dec. 15, 2011

(54) ILLUMINATION DEVICE

(75) Inventor: Yuzuru Shimizu, Osaka (JP)

(73) Assignee: SHARP KABUSHIKI KAISHA, Osaka-shi, Osaka (JP)

(21) Appl. No.: 13/202,990

(22) PCT Filed: Feb. 1, 2010
(86) PCT No.: PCT/JP2010/051330

§ 371 Date: Aug. 24, 2011

(30) Foreign Application Priority Data
Feb. 25, 2009 (JP) 2009-042517

(51) Int. Cl. F21V 7/04

(52) U.S. Cl. 362/613

(57) ABSTRACT

A backlight serving as an illumination device includes an LED substrate having a main surface, and plurality of light source units. Each light source unit includes a light guide plate guiding light frontward of the main surface, and a fixture pin provided at the light guide plate for affixing the light guide plate to the LED substrate. The plurality of light source units are arranged planarly on the main surface such that the fixture pin of one light source unit is covered with the light guide plate of an adjacent light source unit to be hidden. The light guide plate is provided pivotable about the fixture pin relative to the LED substrate. By such a configuration, there is provided an illumination device superior in workability at the time of component-exchange of a light source unit.

### TECHNICAL FIELD

The present invention generally relates to illumination devices, more particularly, a tandem type illumination device having light guide plates arranged to overlap each other partially at a site where a plurality of light source units adjoin.

### BACKGROUND ART

In association with a conventional illumination device, there is known a backlight of a liquid crystal display device including a plurality of light source units formed of a light guide plate and a plurality of light sources provided at an end face of the light guide plate. In such a backlight, a plurality of light source units are coupled in the direction of the primary light emitted from the light source such that light guide plates partially overlap each other at adjoining positions. These backlights are generally referred to as the tandem type.

### SUMMARY OF INVENTION

### Technical Problem

In a backlight of a liquid crystal display device, there may be a case where a component in a certain light source unit must be exchanged, after a plurality of light source units are mounted on a base member serving as the foundation. This is disadvantageous to a tandem-type backlight that will have a plurality of light source units overlapping on the light source unit that is the subject of exchange since, in the order opposite to that of mounting, all the light source units overlapping on the target light source unit must be disassembled. Therefore, considerable number of processing steps is required, significantly degrading the workability in component-exchange of the light source unit.

In view of solving the aforementioned problem, an object of the present invention is to provide an illumination device superior in workability at the time of component-exchange of a light source unit.

### Solution to Problem

An illumination device according to the present invention includes a base member having a main surface, and a plurality of light source units. Each light source unit includes a light guide plate guiding light frontward of the main surface, and a fixture provided at the light guide plate to fasten the light guide plate relative to the base member. The plurality of light source units are arranged planarly on the main surface such that the fixture of one light source unit is covered with the light guide plate of an adjacent light source unit to be hidden. The light guide plate is provided pivotable about the fixture side identified as the fulcrum, relative to the base member.

When a component in a certain light source unit has to be exchanged in the illumination device of the above-described configuration, the light guide plate of each of light source units overlapping on the certain light source unit is sequentially caused to pivot about the fixture side identified as the fulcrum. Accordingly, the fixture of the certain light source unit is exposed, unhidden by the light guide plate of an adjacent light source unit, to allow access to the fixture. As a result, the workability at the time of component-exchange of a light source unit can be improved.

Preferably, the light source unit further includes a light source emitting light towards the light guide plate. The plurality of light source units are arranged planarly on the main surface such that the light source of one light source unit is covered with the light guide plate of an adjacent light source unit to be hidden.

When the light source of a certain light source unit has to be exchanged in the illumination device of the above-described configuration, the light guide plate of each of light source units overlapping on the certain light source unit is sequentially caused to pivot about the fixture side identified as the fulcrum. Accordingly, the light source of the certain light source unit is exposed, unhidden by the light guide plate of an adjacent light source unit, to allow access to the light source. As a result, the workability at the time of exchanging a light source unit can be improved.

More preferably, the light guide plate and fixture are formed integrally by resin. According to the illumination device of the above-described structure, the light source unit can take a simple configuration.

Preferably, the base member is formed with an insertion hole, open at the main surface. The fixture has a pin shape for insertion into the insertion hole in a detachable manner. According to an illumination device of the above-described configuration, the workability in attaching and removing the light guide plate with respect to the base member can be improved.

Also preferably, the light source unit includes a plurality of light guide plates formed integrally by resin. Since the total number of light source units is reduced in the illumination device configured as set forth above, the workability in attaching a light source unit can be improved, and the configuration of the illumination device can be simplified.

Further preferably, the light source unit further includes a light source emitting light towards the light guide plate. The base member is a substrate on which a light source is mounted. The illumination device further includes a support member supporting the plurality of light source units via the substrate, and a fastening member fastening the substrate to the support member. The plurality of light source units are arranged planarly on the main surface such that the fastening member is covered with the light guide plate of one light source unit to be hidden.

In the case where the light source units are to be exchanged together with the substrate in the illumination device configured as set forth above, the light guide plate covering the fastening member and the light guide plate overlapping that light guide plate are sequentially caused to pivot about the fixture side identified as the fulcrum. Accordingly, the fastening member can be exposed, unhidden by the light guide plate, to allow access to the fastening member. As a result, the workability in exchanging the light source unit together with the substrate can be improved.

### ADVANTAGEOUS EFFECTS OF INVENTION

As described above, according to the present invention, there can be provided an illumination device superior in the workability at the time of component-exchange of a light source unit.

### BRIEF DESCRIPTION OF DRAWINGS

FIG. 1 is a sectional view of a liquid crystal display device where a backlight according to a first embodiment of the present invention is employed.

FIG. 2 is a perspective view representing a light source assembly in FIG. 1.

FIG. 3 is a perspective view representing a light source unit in FIG. 2.

FIG. 4 is a sectional view representing a light source unit taken along line IV-IV in FIG. 3.

FIG. 5 is a side view representing an assembling process of a light source assembly in FIG. 2.

FIG. 6 is a side view representing a light source unit of a backlight according to a second embodiment.

FIG. 7 is a side view representing another light source unit of a backlight according to the second embodiment of the present invention.

FIG. 8 is a perspective view of a light source unit of a backlight according to a third embodiment of the present invention.

FIG. 9 is a side view representing an assembling process of a light source assembly formed of the light source units in FIG. 8.

FIG. 10 is a perspective view representing a light source unit in a backlight according to a fourth embodiment.

### DESCRIPTION OF EMBODIMENTS

Embodiments of the present invention will be described with reference to the drawings. In the drawings referred to hereinafter, the same or corresponding member has the same reference number allotted.

### First Embodiment

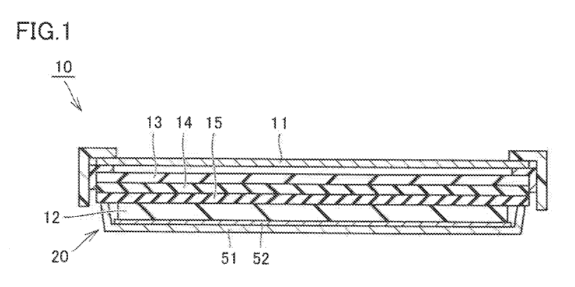

FIG. 1 is a sectional view representing a liquid crystal display where a backlight according to the first embodiment of the present invention is employed. Referring to FIG. 1, first the configuration of liquid crystal display device 10 will be briefly described. Liquid crystal display device 10 includes, as the main configuration, a liquid crystal panel 11 and a backlight 20.

Backlight 20 is provided at the side opposite to the display face of liquid crystal panel 11 to emit light thereto. Backlight 20 includes a light source assembly 12, an LED substrate 52, a backlight chassis 51, a prism sheet 13, a diffusion sheet 14, and a diffusion plate 15.

Light source assembly 12 is arranged apart from liquid crystal panel 11 to be opposite thereto. Light source assembly 12 emits light towards liquid crystal panel 11. Light source assembly 12 is supported by backlight chassis 51 serving as a support member via LED substrate 52. Backlight chassis 51 is provided to cover LED substrate 52 and light source assembly 12 from the backside of liquid crystal display device 10.

As an optical member, diffusion plate 15, diffusion sheet 14 and prism sheet 13 are formed in a panel like or sheet-like form. Diffusion plate 15, diffusion sheet 14, and prism sheet 13 are arranged between light source assembly 12 and liquid crystal panel 11. Diffusion plate 15, diffusion sheet 14 and prism sheet 13 are stacked on light source assembly 12 in the cited order.

Diffusion plate 15 is provided to alleviate the occurrence of difference in brightness of light emitted from light source assembly 12 in the area of liquid crystal panel 11. Diffusion sheet 14 serves to provide the optimum orientation property according to the type of usage of liquid crystal display device 10. Prism sheet 13 is provided to converge light in a particular direction. The optical members used for backlight 20 are not limited to the above combination, and may be modified appropriately according to the optical performance required for liquid crystal display device 10.

The configuration of liquid crystal panel 11 is not particularly limited, and any well-known liquid crystal panel can be employed appropriately. By way of example, liquid crystal panel 11 is configured including an active matrix substrate having a plurality of TFTs (Thin Film Transistors) formed, and an opposite substrate arranged facing the active matrix substrate, wherein a liquid crystal layer is sealed in by a sealing member between the pair of substrates.

A configuration of a backlight 20 according to the present embodiment employed in liquid crystal display device 10 shown in FIG. 1 will be described in detail hereinafter.

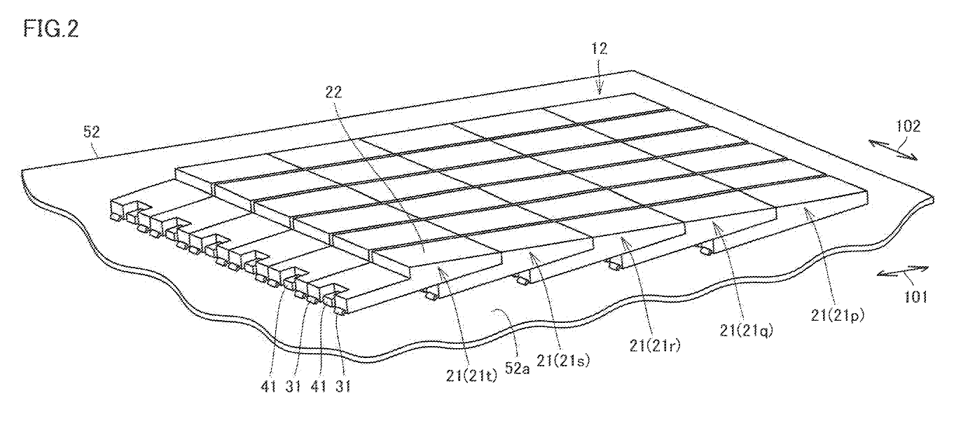

FIG. 2 is a perspective view of the light source assembly in FIG. 1. Referring to FIG. 2, an LED substrate 52 includes a main surface 52a. Main surface 52a faces liquid crystal panel 11 in FIG. 1, and is formed extending two-dimensionally.

Light source assembly 12 is formed having a plurality of side light (edge light) type light source units 21 combined. Light source units 21 are arranged to align in one direction (the direction indicated by arrow 101) and juxtaposed in a direction (direction indicated by arrow 102) orthogonal to the aligning direction on main surface 52a. In FIG. 2, light source units 21p, 21q, 21r, 21s and 21t are aligned in the cited order along the direction indicated by arrow 101. Plurality of light source units 21 are provided to be arranged planarly on main surface 52a. In FIG. 2, only a portion of light source units 21 actually arranged at backlight 20 is shown.

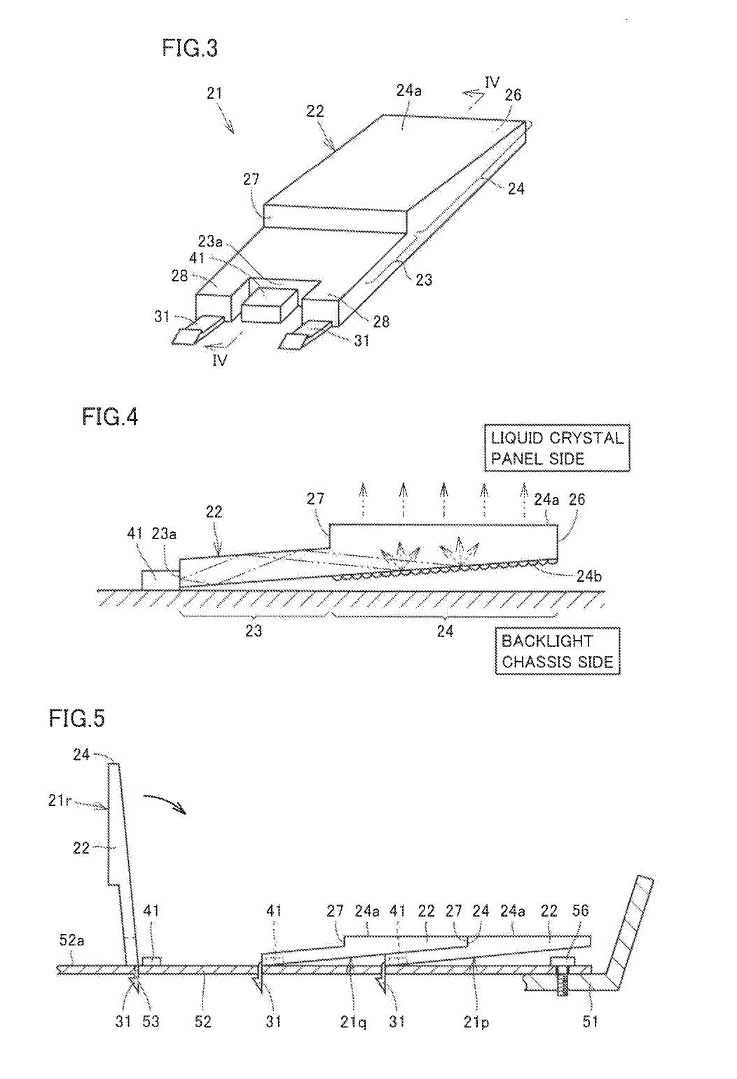

FIG. 3 is a perspective view of a light source unit in FIG. 2. FIG. 4 is a sectional view showing a light source unit taken along line IV-IV in FIG. 3.

Referring to FIGS. 3 and 4, each light source unit 21 includes an LED chip 41, a light guide plate 22, and a fixture pin 31. LED chip 41 is mounted on main surface 52a. LED chip 41 is provided as a dot-type light source. Fixture pin 31 is provided at light guide plate 22 to affix light guide plate 22 to LED substrate 52. LED chip 41 and light guide plate 22 affixed to LED substrate 52 are located close to each other.

Light guide plate 22 is formed of transparent resin that allows light transmission. For example, light guide plate 22 is formed of transparent resin such as (meta) acryl resin including PMMA (polymethyl methacrylate) and the like, COP (Cyclo Olefin Polymer) such as “Zeonor” (registered trademark, Japan Zeon Corporation), COC (Cyclo Olefin Copolymer), polycarbonate and the like. Light guide plate 22 serves to deflect (reflect) the incident light from LED chip 41 inside for output towards liquid crystal panel 11.

Light guide plate 22 includes, as constituent sites, a light guide region 23 and an illumination region 24. Light guide region 23 and illumination region 24 are formed integrally by resin. In the direction of light output from LED chip 41, light guide region 23 is located relatively close to LED chip 41 whereas illumination region 24 is located relatively farther away from LED chip 41.

Light guide region 23 includes a light receiving face 23a. Light receiving face 23a extends in the plane crossing (orthogonal to) main surface 52a in the state where light guide plate 22 is affixed to LED substrate 52. LED chip 41 is arranged in contact with or adjacent to light receiving face 23a. Light guide region 23 guides incident light from light receiving face 23a towards illumination region 24.

Illumination region 24 includes a light emitting face 24a and a light scattering face 24b. Light emitting face 24a is formed facing liquid crystal panel 11 in FIG. 1. The light guided from light guide region 23 to illumination region 24 exits from light emitting face 24a. Light scattering face 24b is formed at the backside of light emitting face 24a. Light scattering face 24b causes the light guided from light guide region 23 to scatter inside illumination region 24 for output through light emitting face 24a outside of light guide plate 22. Light scattering face 24b is formed by applying, for example, prism processing or surface texturing to the surface of illumination region 24.

Light guide plate 22 includes a stepped portion 27 and an end portion 26. Stepped portion 27 is provided between light guide region 23 and illumination region 24. Stepped portion 27 is formed such that illumination region 24 protrudes towards liquid crystal panel 11 in FIG. 1 than light guide region 23. End portion 26 is located at an end of illumination region 24. Stepped portion 27 and end portion 26 are located at respective sides of light emitting face 24a in the direction of light output from LED chip 41.

Light guide plate 22 includes a pair of legs 28. Legs 28 are formed protruding from light guide region 23 towards the side opposite to illumination region 24. LED chip 41 is positioned between legs 28 constituting a pair.

FIG. 5 is a side view representing the assembling process of the light source assembly in FIG. 2. Referring to FIGS. 3-5, a fixture pin 31 and light guide plate 22 are formed integrally by resin in the present embodiment.

Fixture pin 31 is provided in a coupled manner with each of legs 28 constituting a pair. Fixture pin 31 is formed protruding from leg 28 towards the side opposite to light guide region 23.

LED substrate 52 has an insertion hole 53 formed. Insertion hole 53 is open at main surface 52a so as to penetrate LED substrate 52. Fixture pin 31 has a pin shape to be inserted into insertion hole 53 in a detachable manner. The leading end of fixture pin 31 has a hook shape to prevent insertion hole 53 from being readily detached.

In the present embodiment, fixture pin 31 is thin at the connecting region with leg 28. Light guide plate 22 is formed of transparent resin that is particularly superior in flexibility. By such a configuration, fixture pin 31 is formed to allow repeated bending at the connecting position between fixture pin 31 and leg 28. By such a bending type fixture pin 31, light guide plate 22 is provided pivotable about fixture pin 31 side identified as the fulcrum, relative to LED substrate 52.

Referring to FIG. 5, in the assembling process of light source assembly 12, light guide plate 22 is fixed to LED substrate 52 on which LED chip 41 is mounted. At this stage, fixture pin 31 is inserted into insertion hole 53 with light guide plate 22 in an upright state on main surface 52a. Light guide plate 22 is caused to pivot about fixture pin 31 side to be tilted down on main surface 52a to attain the form of light source assembly 12. In order to prevent excessive force from being exerted on LED chip 41 in contact with light guide plate 22 at this stage, light guide plate 22 may be affixed with a certain level of play with respect to LED substrate 52.

Since plug-in type fixture pin 31 is used for the fixture of light guide plate 22 in the present embodiment, the workability in assembling light source assembly 12 can be improved as compared to the case where a bolt for fastening is used.

Referring to FIGS. 2 and 5, light source units 21 are arranged on main surface 52a such that adjacent light guide plates 22 partially overlap each other. With regard to light source units 21p, 21q and 21r shown in FIG. 5, for example, light guide region 23 of light source unit 21p overlaps with illumination region 24 of light source unit 21q, and light guide region 23 of light source unit 21q overlaps with illumination region 24 of light source unit 21r. By the coincidence of stepped portion 27 and end portion 26 between adjacent light source units 21, light emitting faces 24a of plurality of light source units 21 are flush with each other.

By backlight 20 with the configuration set forth above, fixture pin 31 and LED chip 41 of a certain light source unit 21 (for example, light source unit 21p) will be covered with light guide plate 22 of another light source unit 21 (for example, light source unit 21q) overlapping the certain light source unit 21 to be hidden. In the present embodiment, LED substrate 52 is fastened to backlight chassis 51 by means of a bolt 56 serving as a fastening member. Bolt 56 is arranged at a site hidden by light guide plate 22 of light source unit 21p.

In the case where light guide plate 22 or LED chip 41 of a light source unit 21p, for example, is to be component-exchanged at the time when a component error is detected in the inspection process or at the time of maintenance service of a failed component, fixture pin 31 and LED chip 41 of light source unit 21p that are the target of exchange cannot be accessed since they are hidden by light guide plate 22 of light source unit 21q. Further, in the case where light source assembly 12 is to be exchanged together with LED substrate 52, bolt 56 cannot be removed since it is hidden by light guide plate 22 of light source unit 21p. Although a possible approach is to sequentially removing a light guide plate 22 of a light source unit 21 up to the site where the component that is the target of exchange is exposed, this will require considerable number of processing steps.

In contrast, backlight 20 of the present embodiment has light guide plate 22 provided in a tiltable manner on main surface 52a of LED substrate 52. By such a configuration, in the case where the component of light guide plate 22 or LED chip 41 of light source unit 21p is to be exchanged, light guide plate 22 of light source units 21t, 21s, 21r and 21q arranged in line with light source unit 21p is sequentially set at an upright state from main surface 52a. Accordingly, fixture pin 31 and LED chip 41 of light source unit 21p are exposed, unhidden by light guide plate 22 of light source unit 21q, to allow component-exchange to be facilitated. In the case where light source assembly 12 is to be exchanged completely together with LED substrate 52, light guide plates 22 of light source units 21t, 21s, 21r, 21q and 21p are sequentially tilted up from main surface 52a. Accordingly, bolt 56 is exposed, unhidden by light guide plate 22 of light source unit 21p, to facilitate access to bolt 56.

In summarization, backlight 20 serving as an illumination device according to the first embodiment of the present invention includes LED substrate 52 as the base member having a main surface 52a, and a plurality of light source units 21. Each light source unit 21 includes a light guide plate 22 guiding light frontward of main surface 52a, and a fixture pin 31 provided at a light guide plate 22, functioning as a fixture for affixing light guide plate 22 to LED substrate 52. A plurality of light source units 21 are arranged planarly on main surface 52a such that fixture pin 31 of one light source unit 21 (for example, light source unit 21p) is covered with light guide plate 22 of an adjacent light source unit 21 (for example, light source unit 21q) to be hidden. Light guide plate 22 is provided pivotable about fixture pin 31 side identified as the fulcrum, relative to LED substrate 52.

According to backlight 20 of the first embodiment in the present invention configured as set forth above, the workability in exchanging a component in light source unit 21 (light guide plate 22, LED chip 41) can be improved.

### Second Embodiment

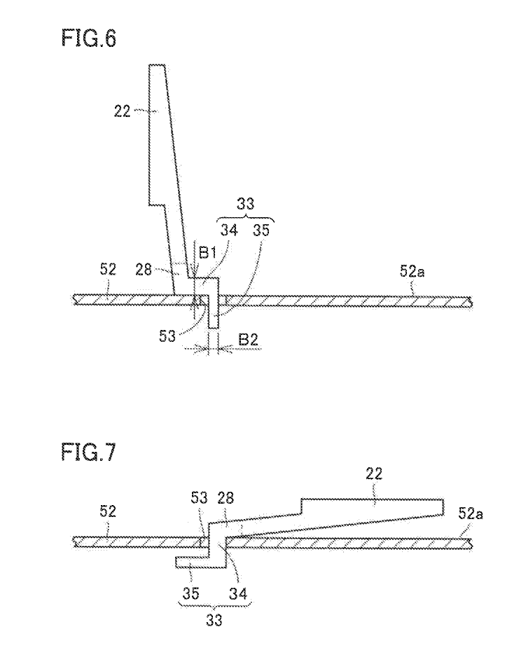

FIGS. 6 and 7 are side views of a light source unit of a backlight according to a second embodiment of the present invention. The backlight of the present embodiment has a configuration basically similar to that of backlight 20 of the first embodiment. Therefore, duplicative description of the configuration will not be repeated hereinafter.

Referring to FIGS. 6 and 7, light guide plate 22 of the present embodiment has a fixture hook 33 provided as a fixture instead of fixture pin 31 in the first embodiment. Fixture hook 33 and light guide plate 22 are formed integrally by resin. Fixture hook 33 is provided in a coupled manner with a pair of legs 28. Fixture hook 33 has a hook shape to be inserted into an insertion hole 53 in a detachable manner.

The shape of fixture hook 33 will be described more specifically hereinafter. Fixture hook 33 includes, as constituent sites, a basal portion 34 and an extremity portion 35. Basal portion 34 is bent from leg 28 and is formed extending at light scattering face 24b side in FIG. 4. Extremity portion 35 is bent from basal portion 34 to extend at the side opposite to illumination region 24 in FIG. 4. Basal portion 34 has a thickness B1, and extremity portion 35 has a thickness B2 smaller than thickness B1.

During the assembly process of light source assembly 12, extremity portion 35 of fixture hook 33 is inserted into insertion hole 53 with light guide plate 22 upright on main surface 52a. Then, light guide plate 22 is caused to pivot about fixture hook 33 side identified as the fulcrum to tilt down on main surface 52a, implementing light source assembly 12. At this stage, basal portion 34 is slid in insertion hole 53 to affix light guide plate 22 to LED substrate 52.

The present embodiment allows a tiltable light guide plate 22 to be realized even in the case where resin of low flexibility is used for light guide plate 22 by virtue of providing a fixture hook 33 having a hook shape at light guide plate 22.

According to the backlight in the second embodiment of the present invention configured as set forth above, advantages similar to those of the first embodiment can be provided.

### Third Embodiment

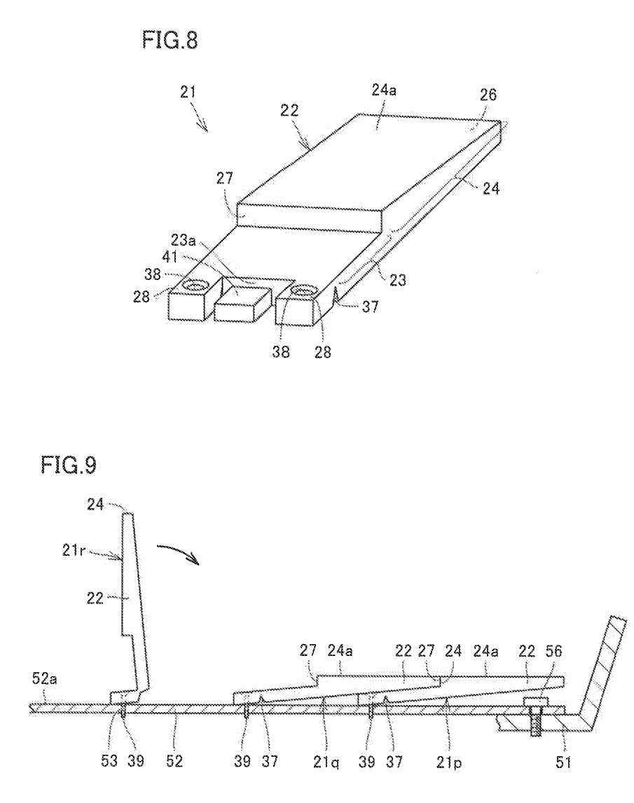

FIG. 8 is a perspective view of a light source unit of a backlight according to a third embodiment of the present invention. FIG. 9 is a side view of an assembling process of a light source assembly formed of the light source units in FIG. 8. The backlight of the present embodiment has a configuration basically similar to that of backlight 20 of the first embodiment. Therefore, duplicative description of the configuration will not be repeated hereinafter.

Referring to FIGS. 8 and 9, the present embodiment has a fixture screw 39 provided as the fixture portion at light guide plate 22, instead of fixture pin 31 of the first embodiment. Fixture screw 39 is provided as a separate component from light guide plate 22. A screw hole 38 is formed in each of legs 28 constituting a pair. Fixture screw 39 is inserted into screw hole 38 and fastened to LED substrate 52. Thus, light guide plate 22 is affixed to LED substrate 52.

Light guide plate 22 has a notch 37 corresponding to a wedge shape formed. Notch 37 is formed along the boundary between leg 28 and light guide region 23. By such a configuration, light guide plate 22 is provided pivotable about a pair of legs 28 having fixture screws 39 provided, relative to LED substrate 52.

According to the backlight in the third embodiment of the present invention configured as set forth above, advantages similar to those of the first embodiment can be provided.

### Fourth Embodiment

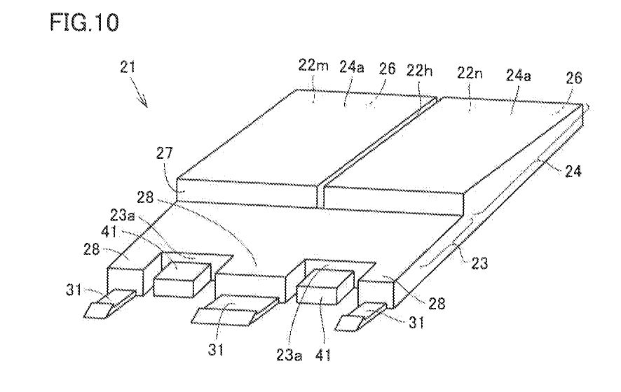

FIG. 10 is a perspective view of a light source unit in a backlight according to a fourth embodiment of the present invention. The backlight of the present embodiment has a configuration basically similar to that of backlight 20 of the first embodiment. Therefore, duplicative description of the configuration will not be repeated hereinafter.

Referring to FIG. 10, a light source unit 21 of the present embodiment includes a plurality of light guide plates 22m and 22n formed integrally by resin, and a plurality of LED chips 41 provided corresponding to and emitting light towards light guide plates 22m and 22n, respectively. Illumination region 24 of light guide plate 22m and illumination region 24 of light guide plate 22n are divided by a slit 22h. Light guide plate 22m and light guide plate 22n share a light guide region 23.

By providing a plurality of light guide plates 22 in one light source unit 21, the total number of light source units 21 required for the backlight in entirety can be reduced. Accordingly, the workability in attaching light source unit 21 can be improved and the number of components in the backlight can be reduced.

The number of light guide plates 22 provided for one light source unit 21 is not limited to 2, and may be three or more.

According to the backlight in the fourth embodiment of the present invention configured as set forth above, advantages similar to that of the first embodiment can be obtained.

Another backlight based on an appropriate combination of the structure of the backlights set forth in the first to fourth embodiments may be provided.

It is to be understood that the embodiments disclosed herein are only by way of example, and not to be taken by way of limitation. The scope of the present invention is not limited by the description above, but rather by the terms of the appended claims, and is intended to include any modification within the scope and meaning equivalent to the terms of the claims.

### INDUSTRIAL APPLICABILITY

The present invention is employed mainly for a backlight of a liquid crystal display device.

### REFERENCE SIGNS LIST

10 liquid crystal display device; 11 liquid crystal panel; 12 light source assembly; 13 prism sheet; 14 diffusion sheet; 15 diffusion plate; 20 backlight; 21, 21p, 21q, 21r, 21s, 21t light source unit; 22, 22m, 22n light guide plate; 22h slit; 23 light guide region; 23a light receiving face; 24 illumination region; 24a light emitting face; 24b light scattering face; 26 end portion; 27 stepped portion; 28 leg; 31 fixture pin; 33 fixture hook; 34 basal portion; 35 extremity portion; 38 screw hole; 39 fixture screw; 41 LED chip; 51 backlight chassis; 52 LED substrate; 52a main surface; 53 insertion hole; 56 bolt.

1. An illumination device comprising:
a base member having a main surface, and
a plurality of light source units including a light guide plate guiding light frontward of said main surface and a fixture affixing said light guide plate to said base member,
said plurality of light source units arranged planarly on said main surface such that said fixture of one light source unit is covered with said light guide plate of an adjacent light source unit to be hidden,
said light guide plate provided pivotable about said fixture side identified as a fulcrum, relative to said base member.

2. The illumination device according to claim 1, wherein
said light source unit further includes a light source emitting light towards said light guide plate,
said plurality of light source units are arranged planarly on said main surface such that said light source of one light source unit is covered with said light guide plate of an adjacent light source unit to be hidden.

3. The illumination device according to claim 1, wherein said light guide plate and said fixture are formed integrally by resin.

4. The illumination device according to claim 1, wherein said base member has an insertion hole formed, open at said main surface,
said fixture has a pin shape to be inserted into said insertion hole in a detachable manner.

5. The illumination device according to claim 1, wherein said light source unit has a plurality of said light guide plates formed integrally by resin.

6. The illumination device according to claim 1, wherein
said light source unit further includes a light source emitting light towards said light guide plate,
said base member is a substrate on which said light source is mounted,
said illumination device further comprising
a support member supporting said plurality of light source units via said substrate, and
a fastening member fastening said substrate with said support member,
said plurality of light source units are arranged planarly on said main surface such that said fastening member is covered with said light guide plate of one light source unit to be hidden.
